(19) United States
(12) Patent Application Publication
(10) Pub. No.: US 2013/0158857 A1
(43) Pub. Date: Jun. 20, 2013

(54) POWER AND PERFORMANCE OPTIMIZATION IN NAVIGATION SYSTEMS

(71) Applicants: Goutam Dutta, Bangalore (IN); Sandeep Rao, Bangalore (IN)

(72) Inventors: Goutam Dutta, Bangalore (IN); Sandeep Rao, Bangalore (IN)

(73) Assignee: Texas Instruments Incorporated, Dallas, TX (US)

(21) Appl. No.: 13/330,434

(22) Filed: Dec. 19, 2011

(51) Int. Cl. G01C 21/00

(52) U.S. Cl. 701/409; 701/408

(57) ABSTRACT

Methods and systems for power and performance optimization are disclosed. In an embodiment, a method of power and performance optimization may include or comprise determining an environment condition of at least one of a current location and one or more intermediate locations along a route of a navigation system based on an environment information. The method also includes or comprises configuring one or more features associated with power and performance optimization in a navigation receiver associated with the navigation system based on the determined environment condition.

### TECHNICAL FIELD

The present disclosure generally relates to the field of power and performance optimization in navigation systems.

### BACKGROUND

Global navigation satellite systems (GNSS) facilitate acquiring and tracking satellite signals for computing a user's positional information (e.g. a location, a speed, a direction of travel, etc.). Typically, a GNSS receiver tracks signals from multiple satellites in one or more satellite systems and uses information included in the signals to compute the location information. Due to various advancements in the GNSS navigation technology, it is now possible to compute the location information in a cost efficient manner. However, due to reliability of GNSS on GNSS satellites, the performance of GNSS is not the same everywhere, and is dependent on the location of the GNSS receiver with respect to the GNSS satellite. For example, the GNSS solutions operating in tunnels or indoors, such as in downtown, or urban canyon environment are prone to jamming, RF (radio frequency) interference and multipath problems. Moreover, in such areas the GNSS solution suffers from power deficiency problems.

### SUMMARY

Methods and systems for power and performance optimization in navigation receivers are disclosed. In an embodiment, the method includes determining an environment condition of at least one of a current location and one or more intermediate locations along a route of a navigation system based on an environment information. The method also includes configuring one or more features associated with power and performance optimization in a navigation receiver associated with the navigation system based on the determined environment condition.

Additionally, in an embodiment, an integrated circuit for power and performance optimization is disclosed, wherein the integrated circuit comprises a receiver subsystem and a power and performance optimization controller. The receiver subsystem is configured to receive signals indicative of a current location associated with a navigation receiver. The power and performance optimization controller is coupled with or connected to the receiver subsystem, and is configured to determine an environment condition of at least one of the current location and one or more intermediate locations in a vicinity of the navigation receiver based on an environment information, and configure one or more features associated with power and performance optimization in the navigation receiver based on the determined environment condition.

Moreover, in an embodiment, a system configured for power and performance optimization is disclosed. The system includes a navigation receiver, a mapping system and a power and performance optimization controller. The navigation receiver includes a receiver subsystem. The receiver subsystem is configured to receive signals indicative of a current location of the navigation system. The mapping system is coupled with the navigation receiver. The mapping system comprises a map database for storing environment information of the current location and one or more intermediate locations in route of the navigation receiver. The power and performance optimization controller is coupled with the navigation receiver and the mapping system, and is configured to determine an environment condition of at least one of the current location and the one or more intermediate locations in vicinity of the navigation system based on the environment information. The power and performance optimization controller is also configured to configure one or more features associated with the power and performance optimization in a navigation receiver based on the determined environment condition.

### BRIEF DESCRIPTION OF THE VIEWS OF THE DRAWINGS

FIG. 1 is a schematic diagram illustrating signal reception by a navigation receiver in an urban environment according to an exemplary embodiment.

FIG. 2 is a block diagram of an integrated circuit according to an embodiment.

FIG. 3 is a block diagram of a navigation system according to an embodiment.

FIG. 4 is a flow chart of a method for optimizing power and performance in a navigation system according to an embodiment.

FIG. 5 is a flow chart of a method of optimizing power and performance in a navigation system according to another embodiment.

FIG. 6 illustrates an exemplary implementation of power and performance optimization in navigation system in accordance with an embodiment.

### DETAILED DESCRIPTION

In an exemplary scenario, a navigation system is configured to determine a position fix. For example, a user of the navigation system may provide a destination location to the navigation system. In response, the navigation system activates the receiver subsystem to deduce an information of a current location of the navigation system. Additionally, the user may be prompted to input a destination location in a user interface associated with the navigation system. Based on the user input for destination location and an information of the current location, the navigation system derives a route from a map database, and suggests the route to the user. In an exemplary embodiment, the receiver subsystem continually provides location information of a currently travelled location along the suggested route to the navigation system, and the navigation system updates the location information accordingly.

In certain exemplary embodiment, the receiver sub-system comprises a Global navigation satellite systems (GNSS) receiver. In certain other embodiments, the GNSS receiver is augmented with certain navigational sensors and/or positioning method, such as WiFi based positioning, cellular based positioning, and the like. The navigational sensors and the available positioning methods provide an accurate positioning information of the navigation system. For example, the navigation system, through the navigation receiver subsystem, receives signals from a plurality of visible satellites orbiting around the earth, and determines its distance from each of the visible satellites. The distance of the navigation receiver from the visible satellites, and the time taken by the signals to reach the receiver, are utilized for deducing a location of the navigation receiver. It is noted that the terminology “visible satellites” may be construed as referring to those satellites that occur in the line-of-sight of the navigation receiver or the navigation system.

The line-of-sight of the satellites may be blocked by natural and unnatural obstructions in a region. For example, in an urban environment or an urban canyon, the line of sight may be blocked by tall buildings and other architectural structures. It is noted that the terminology “urban environment” may be construed as referring to an environment where streets are lined with tall buildings, thereby limiting the view of the sky. Moreover, in an urban environment, the signal from the satellites may arrive at the navigation receiver after reflecting from one or more buildings or other architectural structures. Such signals are known as multipath signals, and this phenomenon is known as a multipath condition. While navigating, a multipath condition is undesirable, because the signals reach the receiver through different paths, and, accordingly, at different points in time.

The navigation systems, such as GNSS provides position fix with certain amount of scatter that depends on various conditions, such as satellite visibility, presence of open sky, effect of multipath affected satellite signals, and the like. In an urban environment, the position fix provided by the navigation system are scattered to a high degree. In order to prevent scatter in urban environment, the navigation system are designed with specialized algorithms. For example, the specialized algorithms may allow the navigation system to operate with tighter bandwidth. Although the navigation system allows the navigation receiver to operate on a duty cycle in the open-sky environment, it would try to maintain the navigation receiver in an ON state in urban environments. In some cases, the navigation system may use sensors, such as inertial sensors and non-inertial sensors to provide better user experience in hostile environments, such as urban environments (or urban canyons). In some other cases, it may include gadgets with additional positioning methods involving Wi-Fi based positioning or, cellular triangulation based positioning. A few, or, all of these techniques may involve power penalty for the navigation receiver, in terms of remaining ON for longer duration, or involving additional hardware (e.g. sensors) for better accuracy.

In an embodiment of the present technology, the use of such specialized algorithms and additional hardware are minimized while system performance is maintained. The present technology utilizes environment information from a mapping system associated with the navigation system to indicate whether the current location comprises a substantially open sky environment or a substantially urban environment. The mapping system also provides information on the environment of the regions in the vicinity of the current location that may help the navigation receiver to switch ON or OFF the sensors.

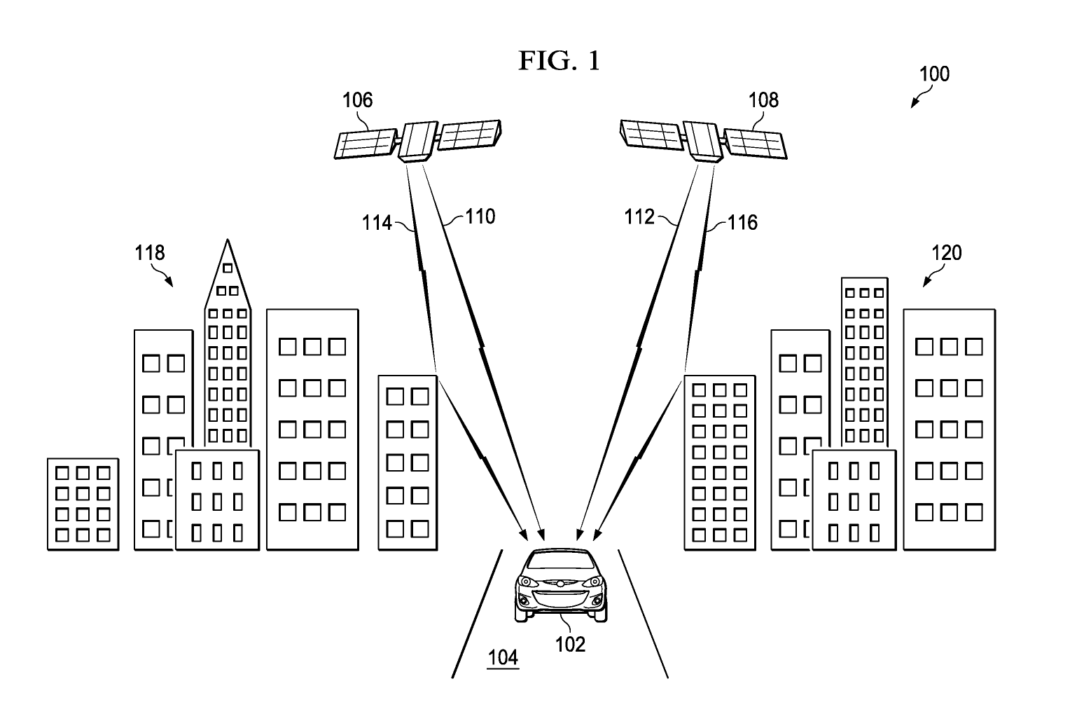

FIG. 1 is a schematic diagram illustrating signal reception by a navigation receiver in an urban environment 100 according to an exemplary embodiment. As illustrated in FIG. 1, a navigation receiver may be integrated in a navigation system associated with a vehicle, such as vehicle 102. It is noted that the vehicle 102 is shown for illustrative purposes, and that it should not be construed as limiting any aspect of the present technology. Additionally, it is noted that any suitable type of navigation receiver assembly, or any other suitable type of tracking system, may be utilized.

The vehicle 102 is shown to be moving on a road 104 in the urban environment 100, which has tall buildings, wherein the navigation receiver (which is installed in the vehicle 102) receives signals from a number of satellites, such as satellites 106, 108. As illustrated herein, the signals are received not only through direct paths, such as path 110 and path 112, but also through reflected multiple paths, such as path 114 and path 116, which is caused by a reflection of the signals by a number of buildings, such as building 118 and building 120 (as shown in FIG. 1). Due to this multipath condition, the signals received at the navigation receiver associated with the navigation system (which is installed in the vehicle 102) may provide an inaccurate position fix.

In an embodiment, when the navigation receiver is operating in an urban environment, the navigation receiver is switched ON most of the time. Moreover, augmentation features, such as inertial and non-inertial sensors, Wi-Fi, cell-based triangulation techniques, and the like, associated with the navigation receiver are continuously switched on, and accordingly, the power requirement of the navigation receiver increases while operating in the urban environment.

For a navigation receiver exposed to an open-sky environment, the power requirement is lower as compared to the navigation receiver operating in an urban environment. In particular, the power consumptions of a navigation receiver may be optimized in a better fashion when the environment in which the navigation receiver is operating is known. For example, in an open-sky environment, a GNSS receiver receives GNSS signals through a direct path (e.g., line-of-sight). Accordingly, in the open-sky environment, the power requirement of the GNSS receiver is less. Also, the GNSS receiver can operate with a low duty cycle while operating in the open-sky environment. Other gadgets augmenting GNSS may be turned off during this time, or, may be selectively used depending on exact requirement.

Various embodiments of the present technology provide methods and systems for power and performance optimization in navigation systems. For example, various embodiments of the present technology discloses a navigation system that is capable of determining whether the user is currently in an open sky environment, or, in an urban canyon based on a map database, a route followed and its current location. Various embodiments of the present technology facilitates the navigation system to anticipate if the navigation system (or a user using the navigation system) is about to enter an urban canyon from an open sky environment or, vice versa. Various embodiments of the present technology facilitates in navigation system to selectively activate and deactivate its power saving features and augmentation techniques based on an information of the environment of the current location as well as one or more intermediate locations along the route. For example, when the navigation system detects that the environment of the current location is benign and performance demands are low, it can either turn-off the power saving features, and de-activate augmentation technologies by turning them off of the receiver sub-system. Similarly, when the navigation system detects the environment of the current location is hostile (e.g. urban canyon), or, the navigator anticipates a hostile environment in near vicinity, it can activate one or more of the augmentation technologies. Some of the augmentation technologies involving inertial and non-inertial sensors require prior calibration with respect to some other reference and needs to be turned on a while before they can actually contribute to better positioning. In some embodiments, a mapping system associated with the navigation system may feature information about WiFi hotspots in urban streets which can prompt the navigation system to turn on its WiFi feature near its vicinity.

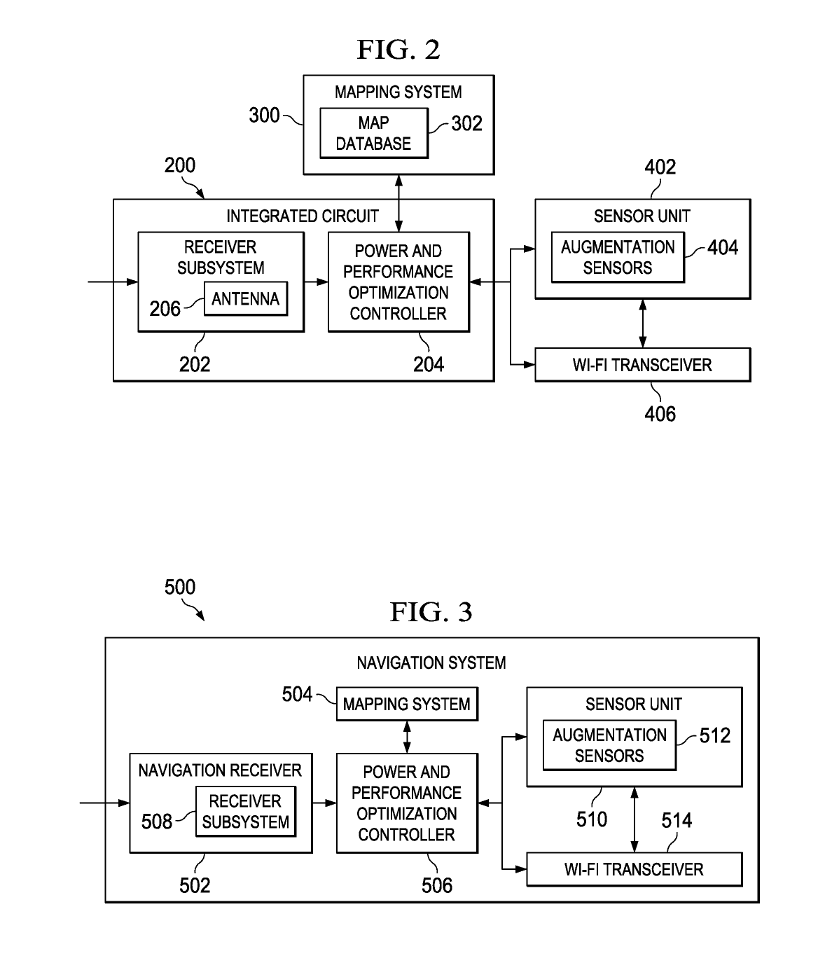

FIG. 2 is a block diagram of an integrated circuit (IC) 200 for power optimization of a navigation system, according to an embodiment. In some embodiments, the IC 200 is a navigation receiver. The IC 200 includes a receiver subsystem 202, and a power and performance optimization controller 204 coupled with or connected to the receiver subsystem 202. The power and performance optimization controller 204 may hereinafter be referred to as controller 204.

The receiver subsystem 202 is configured to receive signals, such as Global Navigation Satellite Systems (GNSS) signals indicative of a current location of the navigation receiver from a plurality of navigational satellites. In some embodiments, the receiver subsystem 202 is configured to receive signals associated with position, timing and other navigational information from the plurality of navigation satellites, such as GNSS, in one or more satellite systems, such as GPS, GLONASS, Galileo and the like.

In an embodiment, the receiver subsystem 202 is a built-in component of a navigation receiver (e.g., a GNSS receiver). Pursuant to one example, the built-in receiver subsystem 202 of the navigation receiver includes an antenna, for example an antenna 206. Examples of the navigation receiver include, but are not limited to, a global positioning system (GNSS) receiver, a Global Navigation Satellite System (GLONASS) receiver, a Galileo™ system receiver, and other navigation system receivers.

The controller 204 is coupled with or connected to the receiver subsystem 202. In some embodiments, the controller 204 is configured to determine environment condition of at least one of the current location and the one or more intermediate locations (along a route) associated with the navigation receiver. In an embodiment, the route between the current location and the one or more destination locations is suggested by the navigation system.

In an embodiment, the controller 204 is configured to determine said environment conditions based on an environment information. In various embodiments, the environment information may include a demarcation of a region having a substantially open-sky environment and a substantially urban environment. The open sky environment facilitates the receipt of signals (e.g., GNSS signals) from satellites (e.g., GNSS satellites) in an unobstructed manner, while the urban environment renders obstruction in the path of signals being received by the navigation receiver. In some embodiments, the environment information may be provided in the form of a three dimensional display of objects, such as buildings, trees, monuments, and the like, in the urban environment.

In some embodiments, the receiver subsystem 202 is configured to receive the environment information from a mapping system, such as a mapping system 300. In some embodiments, the mapping system 300 includes a map database, such as map database 302, having information associated with the environment of various locations on the map, so that the information may be accessed by the navigation receiver. For example, the mapping system 300 may include localization information regarding the presence (or absence) of one or both of the urban environment and the open sky environment embedded in the map database 302. In an exemplary embodiment, various areas included in the map database 302 may be demarcated as associated with one or both of the urban environment area (or urban canyons) and the open-sky environment. It is noted that various areas in the map, or in the map database, may be demarcated pursuant to a number of other hierarchies apart from the urban environment and the open-sky environment. For example, the map database may be demarcated based on a substantially urban environment, substantially open-sky environment, and the like. In one embodiment, the map or the map database may be demarcated based on the presence of Wi-Fi in an area.

In an embodiment, the demarcation on the map may be performed by dividing the area on the map into smaller rectangular areas, wherein each smaller rectangular region may be stored in a form of 4 points (e.g., approximately 16 bits) in the map database 302. In some embodiments, a road may be stored in the map database as a sequence of nodes, with each node denoting an intersection. Each node (for example, node aₙ) may include a bit indicating the nature of the environment on the segment. In some embodiments, each node of the map database 302 may include an additional bit with localization information associated with the environment of the node. In an embodiment, the storage of the environment information associated with each node may require the storing of an additional bit per node in the map database 302.

The environment information of a location (e.g. the current location and the one or more intermediate locations in the vicinity of the current location) may facilitate the determination of the location to be one of comprising an open-sky environment and an urban environment. In some embodiments, the processor 204 may have either internal or external memories, such as a cache for increasing the processing efficiency. The controller 204 may be interfaced to several other components, such as a number of memory units (e.g., random-access memory (RAM), read-only memory (ROM), and/or other types of memories) and input/output subsystems; these components are not shown for purposes of brevity. These memories are used by the controller 204 to store navigation related information, such as ephemeris data, almanac data, current location, last-known location, and the like, and the environment information, such as urban environment, open-sky environment, and the like. The memories can also be configured to store program instructions to be executed by the controller 204. The controller 204 is also operatively connected to or coupled with an input/output subsystem in order to communicate with external devices.

In an embodiment, the controller 204 configures one or more features associated with power and performance optimization of the navigation system based on the determined environment conditions. In an embodiment, the one or more features may include a power save mode, and performance augmentation features such as augmentation sensors, Wi-Fi transceiver, cellular triangulation, pseudolite receivers and the like associated with the navigation receiver. For example, upon determining the environment condition of the current location to be open-sky environment, the controller 204 configures the power save mode associated with the navigation system, thereby configuring a low duty cycle of the navigation receiver. Additionally or alternatively, the controller 204 is configured to activate the performance augmentation features of the navigation receiver, power save mode associated with the navigation system based on the environment conditions.

In an embodiment, the navigation performance features of the navigation receiver include augmentation sensors and Wi-Fi transceiver. For example, the processor 204 may be coupled with or connected to a sensor unit, such as sensor unit 402 comprising augmentation sensors (for example, augmentation sensors 404), and a Wi-Fi transceiver 406.

In another example embodiment, when the environment of the current location is determined to be urban environment, or when the environment of the current location is open-sky but that of an intermediate location in a nearby vicinity is urban environment, the controller 204 is configured to deactivate the power save mode of the navigation receiver. Additionally or alternatively, the controller 204 is configured to trigger switching-on of the performance augmentation features of the navigation receiver. In some embodiments, the controller 204 may reside on the integrated chip 200 or on a separate micro-controller that is external to the integrated chip 200. For example, in FIG. 2, the controller 204 is shown and described to be integrated with the IC 200. In various other exemplary configurations, the controller 204 may reside external to the IC comprising receiver subsystem 202, the sensor unit and the Wi-Fi transceiver, without limiting the scope of the present disclosure.

In various embodiments, the controller 204 is configured to switch-on the performance augmentation features associated with the navigation receiver when the controller 204 determines that the current location includes or resides within an open-sky environment, and that the intermediate location (in the vicinity of the current location) includes or resides within an urban environment. In an embodiment, the controller 204 may facilitate a calibration of one or more augmentation sensors while being in the open-sky environment to thereby enable the sensors to accurately determine a position fix when the navigation receiver enters the urban environment in close vicinity. To facilitate such calibration, the sensors may be switched on at appropriate times with the navigation receiver still being in an open-sky environment. The exact point of switching on the sensors would depend on the typical time required to calibrate such sensors as determined by prior experience. Examples of the augmentation sensors include, for example, gyroscopes, accelerometers, electronic compasses, altimeter, and the like. In an embodiment, the controller 204 configures the Wi-Fi transceiver to download a local Wi-Fi access point (AP) information prior to entering the urban environment.

In another embodiment, the processor 204 facilitates a deactivation of the augmentation sensors upon determining that the current location includes or resides within the urban environment, and that the immediately approaching intermediate (in the nearby vicinity of the current environment) includes or resides within the open-sky environment. It is noted that the processor 204 will deactivate the augmentation sensors only after leaving the current location, thereby maintaining the efficient navigational performance of the navigation system.

In one embodiment, the augmentation sensors may reside on the IC 200 or on a separate micro-controller that is external to the IC 200. For example, in FIG. 2, the one or more augmentation sensors are shown external to the IC 200. An exemplary configuration, wherein the augmentation sensors are integrated with the IC, is explained herein with regard to FIG. 3.

FIG. 3 is a block diagram of a navigation system 500 according to an embodiment. The navigation system 500 includes a navigation receiver, such as a navigation receiver 502, a mapping system 504, and a power and performance optimization controller 506 (hereinafter referred to as controller 506). The navigation receiver 502 includes a receiver subsystem 508. The controller 506 is configured to configure one or more features for power and performance optimization in the navigation system 500. In an embodiment, the one or more features includes a sensor unit 510 having augmentation sensors 512, and a Wi-Fi transceiver 514. The augmentation sensors 512 are calibrated for accurate location determination. It is noted that the calibration of the augmentation sensors 512 may be performed using a variety of techniques, and that the present technology is not limited to any particular calibration methodology. In some embodiments, the one or more augmentation sensors include, for example, an accelerometer, electronic compass, gyroscope, altimeter and the like. In some embodiments, the controller 506 and the receiver subsystem 508 are similar to the controller 204 the receiver subsystem 202 respectively, of the IC 200. Also, in some embodiments, the sensor unit 510, the segmentation sensors 512 and the Wi-Fi transceiver 514 are similar to the sensor unit 402, the segmentation sensors 404 and the Wi-Fi transceiver 406, and are accordingly not explained herein for the sake of brevity of description.

In some embodiments, the navigation receiver 502 is a GNSS receiver. It is noted that the navigation receiver 502 will include various other components associated with a conventional navigation receiver, such as a front-end processing block, and a baseband processing element, an analog-to-digital converter, and other such components that have not been shown in FIG. 3 and explained herein for the sake of brevity. The navigation receiver 502 is coupled with or connected to the controller 506.

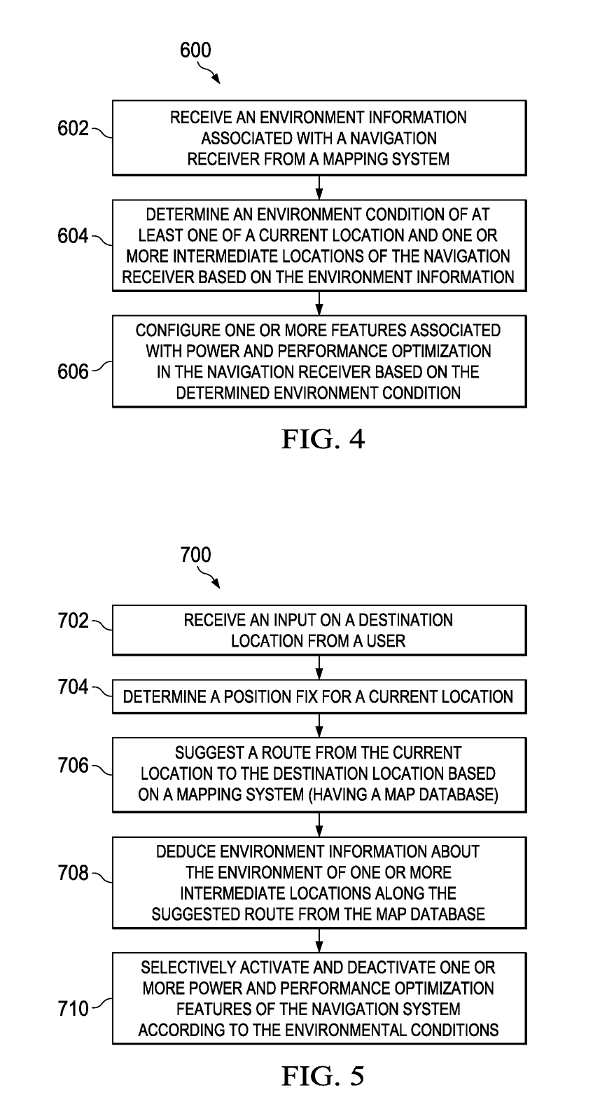

FIG. 4 is a flowchart 600 of a method for power and performance optimization in a navigation system according to an embodiment. For purposes of illustration, the flowchart is described with respect to the device and components of FIGS. 2 and 3, and in relation to a navigation receiver including a power and performance optimization controller, and one or more augmentation sensors in a navigation system. However, various features described herein can be implemented in other environments and using other components. Furthermore, the steps in the flowchart are described in a specific sequence for purposes of illustration. Alternative embodiments using a different sequence of steps can also be implemented without departing from the scope and spirit of several aspects of the present technology.

At 602, environment information associated with a current location and one or more intermediate locations is received from a mapping system. The mapping system is coupled with or connected to the navigation system. As described in conjunction with FIGS. 2 and 3, the environment information is received by a receiver subsystem, such as the receiver subsystem 502. Examples of the receiver system include an RF antenna, or a serial wired connection coupled or associated with the navigation system, such as the navigation system 500.

At 604, an environment condition of at least one of a current location and one or more intermediate locations of a navigation receiver based on the environment information is determined. As disclosed in FIGS. 2 and 3, the environment condition may be determined by a controller, such as the controller 506.

At 606, a configuration of one or more features associated with power and performance optimization are configured based on the determined environment condition. For example, the one or more features may include power save mode associated with the navigation receiver, and performance augmentation features. In an embodiment, the performance augmentation features may include augmentation sensors, Wi-Fi transceiver cellular triangulation, pseudolite receivers, and the like. Examples of the augmentation sensors may include a gyroscope, an accelerometer, altimeter, an electronic compass, and the like. In some embodiments, the controller, such as the controller 506, is configured to facilitate a configuration of one or more features.

In an embodiment, when the environment condition of the current location is determined to be associated with a substantially open-sky environment, the one or more features are configured by activating the power save mode associated with the navigation receiver. Further, the switching off of the performance augmentation features may be triggered. In another embodiment, the one or more features are configured by deactivating the power save mode associated with the navigation receiver and switching-on of the performance augmentation features is triggered, when the environment condition of the current location is determined to be associated with a substantially urban environment.

In yet another embodiment, configuring the one or more power optimization features includes or comprises deactivating a power save mode associated with the navigation receiver when the one or more intermediate locations in a vicinity of the current location are associated with a substantially urban environment, and the current location is associated with a substantially open-sky environment. In one embodiment, configuring the one or more power optimization features includes or comprises deactivating the power save mode associated with the navigation receiver when the one or more intermediate locations (which may be in close vicinity) include or comprise a substantially open-sky environment and the current location includes or comprises a substantially urban environment.

In an embodiment, the method 600 may also include facilitating a configuration of one or more augmentation features associated with the navigation receiver based on the environment of the current location and the one or more intermediate locations. In some embodiments, configuring an augmentation feature of the one or more augmentation features includes activating or deactivating one or more augmentation sensors, configuring a Wi-Fi access point, and the like. For example, the mapping system associated with the navigation system may include information about WiFi hotspots in urban environment, such as urban streets. When the user enters an urban environment, based on the information from the mapping system, the user can be prompted about the availability of the WiFi hotspots in the suggested route, and the navigation system may enable the user to turn on the WiFi feature of the navigation system near the vicinity of the Wifi hotspot, thereby enhancing the performance of the navigation system.

In an embodiment, the receiver subsystem and the controller may be embodied in a navigation receiver. Examples of the navigation receiver include a GNSS receiver, a Wi-Fi receiver, and the like. It is noted that although the method 600 is explained with respect to a navigation receiver, the method may be implemented on any other device that is capable of receiving information in the form of signals and processing the information to optimize power.

FIG. 5 is a flow chart of a method 700 of optimizing power and performance in a navigation system according to another embodiment. For purposes of illustration, the flowchart is described with respect to the device and components of FIGS. 2 and 3, and in relation to a navigation receiver including a power and performance optimization controller, and one or more augmentation sensors in a navigation system.

In an embodiment, a user may switch on a navigation system, for example, the navigation system 500. The user may switch on the navigation system while travelling from a current location to a destination location, or prior to traveling from the current location to the destination location.

At 702, the navigation system may receive an input of a destination location from the user. In an embodiment, the user may provide the input by utilizing a user interface. In an embodiment, the user interface may be one of a touch screen, audio guided, mouse click, or a similar type of interface that may facilitate the user to input the current and/or destination locations, and in response output a suggested route on a display. At 704, the navigation system may determine a position fix of the current location of the user (or the navigation receiver). In an embodiment, the navigation system may determine the position fix of the current location based on a mapping system, for example the mapping system 504 (refer to FIG. 3) associated with the navigation system 500.

At 706, the navigation system may suggest a route to the user based on the mapping system. Particularly, the mapping system utilizes the information of the current location and the destination location, and suggest a route to the user. It will be understood that in alternative embodiments, the mapping system may suggest more than one route from the current location to the destination locations, and allow the user to select one of routes prior to/during the travel. In an embodiment, the user interface of the navigation system may include a display screen for indicating the suggested route to the user.

At 708, a receiver subsystem such as the receiver subsystem 508 deduces environment information associated with one or more intermediate locations along the suggested route from the map database. In an embodiment, the environment information may include a demarcation of regions having a substantially open-sky environment and a substantially urban environment.

At 710, the navigation system selectively activates and deactivates one or more power and performance optimization features of the navigation system along the route based on the environment information provided by the map database. For example, a user may start from a current location and the suggested route may indicate few urban locations (such as a downtown area) and few open-sky locations (such as a fly-over or an over bridge). So, the navigation receiver, with the help of mapping system (or the map database) would determine that the navigation receiver is about to leave the open sky environment and enter an urban location, or vice-versa. In response, the navigation system would deactivate a power-save mode and enable calibration of performance optimization feature. For example, the navigation system may enable the sensors to be switched on at appropriate times with the navigation system still being in an open-sky environment. The exact point of switching on of the sensors would depend on the typical time required to calibrate such sensors as determined by prior experience. Examples of the augmentation sensors include, for example, gyroscopes, accelerometers, electronic compasses, altimeter, and the like.

It is noted that although the method 700 is explained with respect to a navigation system, the method may be implemented on any other device that is capable of receiving information in the form of signals and processing the information to optimize power.

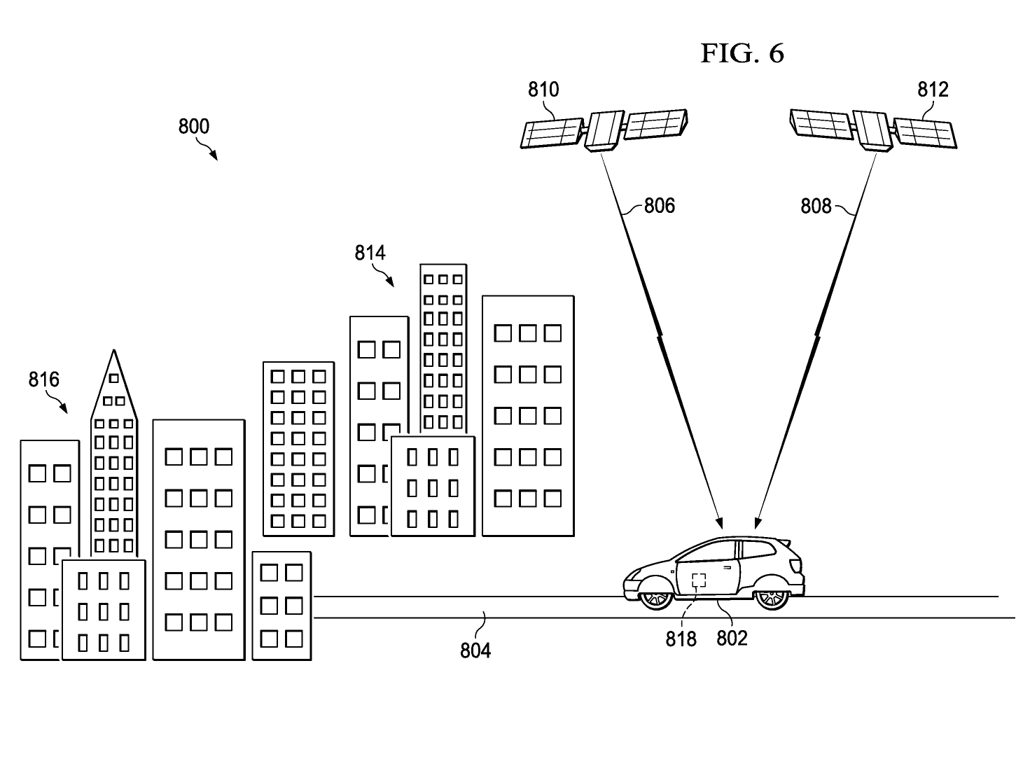

FIG. 6 illustrates an exemplary implementation 800 of power and performance optimization in navigations system in accordance with an embodiment. As illustrated, a vehicle 802 is travelling on a road 804 in an open-sky environment, and is capable of receiving signals, such as signals 806, 808, from satellites, such as GNSS satellites 810, 812. The road 804 is leading the vehicle 802 to an urban environment having multiple tall buildings, such as buildings 814, 816. The vehicle 802 is configured with the power and performance optimization system 918 of the disclosed technology. In an embodiment, the integrated circuit 200 or the navigation system 500 (comprising the power and performance controller 506) may be an example of the power and performance optimization system (herein after referred to as optimization system 818).

Prior to entering the urban environment, the optimization system 818 integrated or associated with the vehicle 802 receives environment information from a mapping system (such as the mapping system 300 and the mapping system 504) informing the navigation system about the presence of an urban environment in one of the intermediate locations in close vicinity of the vehicle 802. Upon determining the presence of the urban environment in one of a number of close intermediate locations, the navigation system facilitates a configuration of and activates one or more features associated with power and performance optimization, such as the deactivation of a power save mode, and one or more augmentation features, such as the calibration of augmentation sensors. Facilitating the deactivation of the power save mode and the calibration of the augmentation sensors before the vehicle 802 enters the urban environment enables the navigation receiver to achieve improved power optimization and improved positioning detection.

Without in any way limiting the scope, interpretation, or application of the claims appearing below, advantages of one or more of the exemplary embodiments disclosed herein is to provide a method for power and performance optimization in a navigation system. Various embodiments provide methods that can enable the sending of a warning prior to a navigation receiver entering an urban canyon or an urban environment, a tunnel, and the like. A knowledge of an approaching urban environment allows the navigation receiver to communicate with a Wi-Fi server and download Wi-Fi access locations prior to entering the urban environment. Various embodiments of the present technology enable calibration of augmentation sensors associated with the navigation system even before entering an urban environment, thereby facilitating an efficient use of augmentation features.

It should be noted that reference throughout this specification to features, advantages, or similar language does not imply that all of the features and advantages should be, or are in, any single embodiment. Rather, language referring to the features and advantages is understood to mean that a specific feature, advantage, or characteristic described in connection with an embodiment is included in at least one embodiment of the present technology. Thus, discussions of the features and advantages, and similar language, throughout this specification may, but do not necessarily, refer to the same embodiment.

Various embodiments of the present disclosure, as discussed above, may be practiced with steps and/or operations in a different order, and/or with hardware elements in configurations which are different than those which are disclosed. Therefore, although the technology has been described based upon these exemplary embodiments, it is noted that certain modifications, variations, and alternative constructions are apparent and well within the spirit and scope of the technology.

Although various exemplary embodiments of the present technology are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A method comprising:
determining an environment condition of at least one of a current location and one or more intermediate locations along a route of a navigation system based on an environment information; and
configuring one or more features associated with power and performance optimization in a navigation receiver associated with the navigation system based on the determined environment condition.

2. The method of claim 1, further comprising:
receiving the environment information from a mapping system associated with the navigation receiver.

3. The method of claim 1, wherein the one or more features comprises:
power save mode associated with the navigation receiver, and
performance augmentation features.

4. The method of claim 3, wherein the performance augmentation features comprises at least one of augmentation sensors, Wi-Fi transceiver, cellular triangulation, and pseudolite receivers, and wherein the augmentation sensors are selected from the group comprising a gyroscope, an accelerometer, altimeter, and an electronic compass.

5. The method of claim 3, wherein configuring the one or more features comprises:
activating the power save mode associated with the navigation receiver, and
triggering a switching off of the performance augmentation features, when the environment condition of the current location and one or more intermediate locations along the route is determined to be associated with a substantially open-sky environment.

6. The method of claim 3, wherein configuring the one or more features comprises:
deactivating the power save mode associated with the navigation receiver, and
triggering a switching-on of the performance augmentation features, when the environment condition of the current location is determined to be associated with a substantially urban environment.

7. The method of claim 3, wherein configuring the one or more features comprises:
deactivating the power save mode associated with the navigation receiver, and
triggering a switching-on of the performance augmentation features, when the environment condition of the one or more intermediate locations in a vicinity of the current location is determined to be associated with a substantially urban environment, and the environment condition of the current location is determined to be associated with a substantially open-sky environment.

8. The method of claim 1, wherein the navigation receiver is a global navigation satellite systems (GNSS) receiver.

9. An integrated circuit configured for power and performance optimization, the integrated circuit comprising:
a receiver subsystem configured to receive signals indicative of a current location associated with a navigation system; and
a power and performance optimization controller coupled with the receiver subsystem and configured to:
determine an environment condition of at least one of the current location and one or more intermediate locations along a route of the navigation system based on an environment information, and configure one or more features associated with power and performance optimization in a navigation receiver associated with the navigation system based on the determined environment condition.

10. The integrated circuit of claim 9, wherein power and performance optimization controller is configured to receive the environment information from a mapping system, the mapping system comprising a map database for storing the environment information of the current location and the one or more intermediate locations.

11. The integrated circuit of claim 9, wherein the receiver subsystem comprises an antenna.

12. The integrated circuit of claim 9, wherein the power and performance optimization controller is capable of activating and deactivating at least one of power save mode and performance augmentation features associated with the navigation receiver.

13. The integrated circuit of claim 12, wherein the performance augmentation features comprises augmentation sensors, Wi-Fi transceiver, cellular triangulation, and pseudolite receivers, and wherein the augmentation sensors are selected from the group comprising a gyroscope, an accelerometer, altimeter, and an electronic compass.

14. The integrated circuit of claim 12, wherein the power and performance optimization controller configures the one or more features by:
activating the power save mode associated with the navigation receiver, and
triggering a switching off of the performance augmentation features, when the environment condition of the current location and one or more intermediate locations along the route is determined to be associated with a substantially open-sky environment.

15. The integrated circuit of claim 12, wherein the power and performance optimization controller configures the one or more features by:
deactivating the power save mode associated with the navigation receiver, and
triggering a switching-on of the performance augmentation features, when the environment condition of the current location is determined to be associated with a substantially urban environment.

16. The integrated circuit of claim 12, wherein the power and performance optimization controller configures the one or more features by:
deactivating the power save mode associated with the navigation receiver, and
triggering a switching-on of the performance augmentation features, when the environment condition of the one or more intermediate locations in a vicinity of the current location is determined to be associated with a substantially urban environment, and the environment condition of the current location is determined to be associated with a substantially open-sky environment.

17. The integrated circuit of claim 9, wherein the navigation receiver is a global navigation satellite systems (GNSS) receiver.

18. A system configured for power and performance optimization comprising:
a navigation receiver comprising a receiver subsystem, the receiver subsystem configured to receive signals indicative of a current location of the navigation system;
a mapping system coupled with the navigation receiver, the mapping system comprising a map database for storing environment information of the current location and the one or more intermediate locations of the navigation receiver; and
a power and performance optimization controller coupled with the navigation receiver and the mapping system, and configured to:
determine an environment condition of at least one of the current location and the one or more intermediate locations along a route of the navigation system based on the environment information, and
configure one or more features associated with the power and performance optimization in the navigation receiver based on the determined environment condition.

19. The system of claim 18, wherein the power and performance optimization controller is capable of activating and deactivating at least one of a power save mode and performance augmentation features associated with the navigation receiver.

20. The system of claim 18, wherein the navigation receiver is a Global navigation satellite systems (GNSS) receiver.
